(19) United States
(12) Patent Application Publication
(10) Pub. No.: US 2025/0125440 A1
(43) Pub. Date: Apr. 17, 2025

(54) COOLING JACKET FOR PRISMATIC CELLS OF A RECHARGEABLE ENERGY STORAGE SYSTEM

(71) Applicant: GM Global Technology Operations LLC, Detroit, MI (US)

(72) Inventors: Alfredo Salituro, Pasadena, CA (US); Konstantinos Triantos, Sterling Heights, MI (US); Ryan Schmidt, Royal Oak, MI (US); Phillip Daniel Hamelin, Clarkston, MI (US); Alexander M. Bilinski, Avoca, MI (US)

(21) Appl. No.: 18/484,869

(22) Filed: Oct. 11, 2023

(51) Int. Cl. H01M 10/6557; H01M 10/613; H01M 10/625; H01M 10/647; H01M 10/653; H01M 10/6555; H01M 10/6568; H01M 10/658

(52) U.S. Cl. CPC H01M 10/6557; H01M 10/613; H01M 10/625; H01M 10/647; H01M 10/653; H01M 10/6555; H01M 10/6568; H01M 10/658; H01M 2220/20

(57) ABSTRACT

A prismatic cell cooling system includes a first prismatic cell having a first face, a second face angularly oriented to the first face and a third face oriented parallel to the first face and angularly oriented to the second face. A cooling jacket provides multiple coolant flow passages. A first cooling segment of the cooling jacket contacts one of the first face or the third face of the first prismatic cell. A second cooling segment of the cooling jacket directly contacts the second face of the first prismatic cell. The second cooling segment is contiguously and fluidly connected to the first cooling segment to promote simultaneous cooling of one of the first face or the third face and the second face of the first prismatic cell by flow of a coolant through the coolant flow passages.

### INTRODUCTION

The present disclosure relates to cooling systems and cooling jackets for automobile energy storage systems.

Certain vehicle prismatic cell designs require increased cooling of prismatic cells when battery powered vehicles such as sports cars and vehicles are used for rapid acceleration, for carrying heavy loads and for towing. Cooling systems for vehicle prismatic cells commonly provide cooling of the prismatic cells using only a single cooling plate contacting a single side of a prismatic cell. The single side cooling concept may not be suitable for vehicle prismatic cell designs requiring enhanced cooling of the prismatic cells.

Thus, while current systems and methods to cool vehicle prismatic cells achieve their intended purpose, there is a need for a new and improved system and method to cool electric vehicle and hybrid vehicle prismatic cells.

### SUMMARY

According to several aspects, a prismatic cell cooling system includes a first prismatic cell having a first face, a second face angularly oriented to the first face and a third face oriented parallel to the first face and angularly oriented to the second face. A cooling jacket provides multiple coolant flow passages. A first cooling segment of the cooling jacket contacts one of the first face or the third face of the first prismatic cell. A second cooling segment of the cooling jacket directly contacts the second face of the first prismatic cell. The second cooling segment is contiguously and fluidly connected to the first cooling segment to promote simultaneous cooling of one of the first face or the third face and the second face of the first prismatic cell by flow of a coolant through the coolant flow passages.

In another aspect of the present disclosure, the cooling jacket defines a second prismatic cell having a cell first face, a cell second face angularly oriented to the cell first face and a cell third face oriented parallel to the cell first face and angularly oriented to the cell second face, the second prismatic cell positioned proximate the first prismatic cell.

In another aspect of the present disclosure, the cooling jacket defines a T-shape having the first cooling segment positioned between and directly contacting the first prismatic cell and the second prismatic cell. M The cooling jacket has the second cooling segment directly contacting both the second face of the first prismatic cell and the cell second face of the second prismatic cell.

In another aspect of the present disclosure, the cooling jacket defines an L-shape having the first cooling segment positioned between and directly contacting the first prismatic cell and the second prismatic cell. The cooling jacket has the second cooling segment directly contacting one of the second face of the first prismatic cell or the cell second face of the second prismatic cell.

In another aspect of the present disclosure, the cooling jacket defines a Z-shape having the first cooling segment positioned between and directly contacting the first prismatic cell and the second prismatic cell. The cooling jacket has the second cooling segment directly contacting the second face of the first prismatic cell, and the cooling jacket includes a third cooling segment directly contacting a cell fourth face of the second prismatic cell.

In another aspect of the present disclosure, the cooling jacket defines a U-shape having the first cooling segment positioned between and directly contacting the first prismatic cell and the second prismatic cell, the cooling jacket having the second cooling segment directly contacting one of the second face of the first prismatic cell or the cell second face of the second prismatic cell.

In another aspect of the present disclosure, a third prismatic cell is provided, wherein: the first cooling segment partially encloses the first prismatic cell; the second cooling segment partially encloses the second prismatic cell; and a third cooling segment of the cooling jacket partially encloses the third prismatic cell.

In another aspect of the present disclosure, a first thermal insulation barrier is positioned between and in direct contact with the first cooling segment and the second cooling segment. A second thermal insulation barrier is positioned between and in direct contact with the second cooling segment and the third cooling segment.

In another aspect of the present disclosure, the cooling jacket includes multiple flow turbulators extending into the coolant flow passages to generate turbulent flow of the coolant, having individual ones of the flow turbulators defining one of a serpentine-shape and a raised pin.

In another aspect of the present disclosure, the second face is oriented substantially perpendicular to the first face and the third face is oriented parallel to the first face and substantially perpendicular to the second face.

According to several aspects, a vehicle prismatic cell cooling system includes at least a first prismatic cell and a second prismatic cell individually having a first face, a second face angularly oriented to the first face and a third face oriented parallel to the first face and angularly oriented to the second face. A first cooling jacket provides multiple coolant flow passages, the first cooling jacket being in direct contact with the first prismatic cell. A first cooling segment of the first cooling jacket contacts one of the first face or the third face of the first prismatic cell. A second cooling segment of the first cooling jacket directly contacts the second face of the first prismatic cell. The second cooling segment is contiguously and fluidly connected to the first cooling segment to promote simultaneous cooling of one of the first face or the third face and the second face of at least the first prismatic cell by flow of a coolant through the coolant flow passages.

In another aspect of the present disclosure, a second cooling jacket is included, the first cooling jacket is in direct contact with the first prismatic cell and the second cooling jacket is in direct contact with the second prismatic cell.

In another aspect of the present disclosure, a third prismatic cell is provided with the at least first and second prismatic cells; and a third cooling jacket is provided, the first cooling jacket is in direct contact with the first prismatic cell, the second cooling jacket is in direct contact with the second prismatic cell and the third cooling jacket is in direct contact with the third prismatic cell.

In another aspect of the present disclosure, the first cooling jacket is further in direct contact with the second prismatic cell; and the second cooling jacket is in direct contact with the third prismatic cell.

In another aspect of the present disclosure, a second cooling jacket is provided, wherein the first cooling jacket is in direct contact with the first prismatic cell and the second cooling jacket is in direct contact with the second prismatic cell.

In another aspect of the present disclosure, a thermal insulation barrier is positioned between and in direct contact with the first cooling jacket and the second cooling jacket.

In another aspect of the present disclosure, a material used for the first cooling jacket includes one of: aluminum, copper and steel; and the first cooling jacket includes multiple turbulation features formed within at least one the first cooling segment and the second cooling segment to increase flow turbulence of the coolant.

According to several aspects, a method for cooling vehicle prismatic cells using cooling jackets comprises: configuring at least a first prismatic cell and a second prismatic cell individually having a first face, a second face angularly oriented to the first face and a third face oriented parallel to the first face and angularly oriented to the second face; positioning a first cooling jacket in direct contact with at least one of the first prismatic cell or the second prismatic cell and providing multiple coolant flow passages within the first cooling jacket; placing a first cooling segment of the first cooling jacket having multiple ones of the multiple coolant flow passages in contact with one of the first face or the third face of the at least one of the first prismatic cell or the second prismatic cell; locating a second cooling segment of the first cooling jacket having multiple ones of the multiple coolant flow passages in direct contact with the second face of the at least one of the first prismatic cell or the second prismatic cell, the second cooling segment contiguously and fluidly connected to the first cooling segment to simultaneously cool one of the first face or the third face and the second face of the at least one of the first prismatic cell or the second prismatic cell by flow of a coolant through the coolant flow passages.

In another aspect of the present disclosure, the method further includes: selecting the first cooling jacket to be in direct contact with the first prismatic cell; and locating a second cooling jacket in direct contact with the second prismatic cell.

In another aspect of the present disclosure, the method further includes thermally isolating the first cooling jacket from the second cooling jacket by positioning a first thermal insulation barrier between and in direct contact with the first cooling jacket and the second cooling jacket.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an end elevational view of a prismatic cell according to an exemplary aspect;

FIG. 2 is an end elevational view of first and second prismatic cells of FIG. 1 configured in a first cooling system of a prismatic cell cooling jacket and manifolding system of the present disclosure;

FIG. 3 is a top perspective view looking rearward of a cooling jacket of FIG. 2;

FIG. 4 is an end elevational view of a prismatic cell similar to FIG. 1;

FIG. 5 is an end elevational view of a three prismatic cell L-shaped cooling system of the present disclosure;

FIG. 6 is an end elevational view of a three prismatic cell U-shaped cooling system of the present disclosure;

FIG. 7 is a top plan view of a cooled four sided prismatic cell according to an exemplary aspect;

FIG. 8 is an end elevational view of a three prismatic cell Z-shaped cooling system of the present disclosure;

FIG. 9 is a side perspective view looking rearward of a Z-shaped cooling jacket of FIG. 8;

FIG. 10 is a front perspective view of the three prismatic cell L-shaped cooling system of FIG. 5 also presenting coolant flow channels; and

FIG. 11 is a front perspective view of the three prismatic cell L-shaped cooling system of FIG. 6 also presenting coolant flow channels.

### DETAILED DESCRIPTION

The following description is merely exemplary in nature and is not intended to limit the present disclosure, application, or uses.

When a component, element or layer is referred to as being “on”, “engaged to”, “connected to”, or “coupled to” another element or layer, it may be directly on, engaged, connected or coupled to the other component, element, or layer, or intervening elements or layers may be present. In contrast, when an element is referred to as being “directly on”, “directly engaged to”, “directly connected to”, or “directly coupled to” another element or layer, there may be no intervening elements or layers present. Other words used to describe the relationship between elements should be interpreted in a like fashion, such as “between” versus “directly between”, “adjacent” versus “directly adjacent”, “proximate” and “directly proximate” and the like. As used herein, the term “and/or” includes any and all combinations of one or more of the associated listed items.

As used herein, the various cooling jacket systems individually have cooling jackets or coolant jackets that include multiple segments having names defining sides, faces, walls, body members, legs and the like used to distinguish different ones of the multiple segments. Prismatic cells as used herein define battery cells or rechargeable energy storage cells having a square or rectangular shape including multiple substantially flat sides. The multiple segments individually include multiple coolant passages, channels and the like providing for flow of a coolant to remove heat from the prismatic cells of the present disclosure.

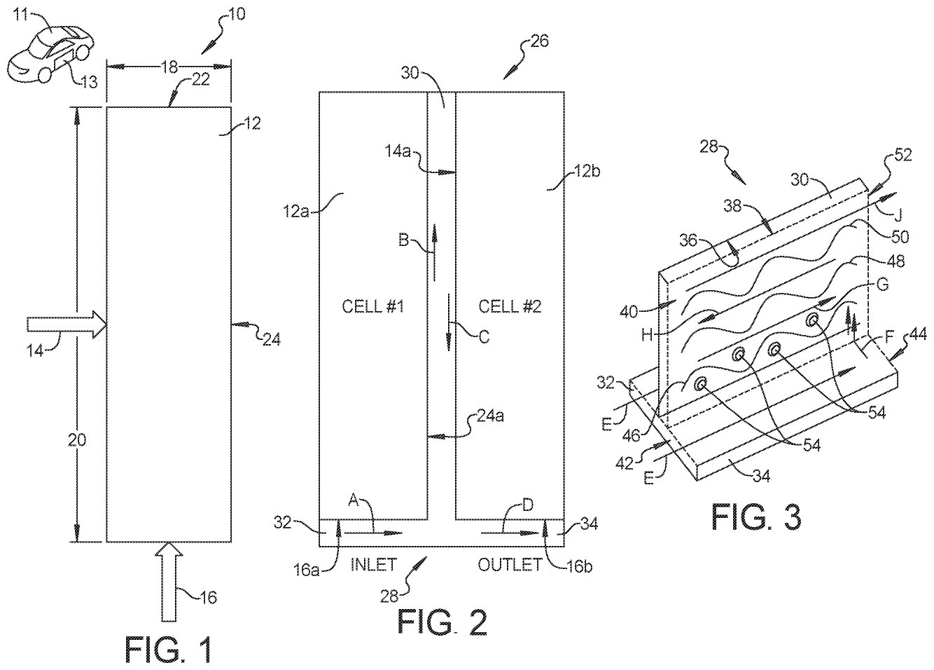

Referring to FIG. 1, a prismatic cell cooling system 10 may be provided for a vehicle 11 such as an automobile, truck, van, sport utility vehicle, sports car, towing vehicle, autonomous vehicle, battery-electric vehicle and the like. The prismatic cell cooling system 10 cools at least one prismatic cell 12 and according to several aspects multiple prismatic cells 12 identified hereinafter with a subletter such as a, b, c and the like. Multiple similar components may also be identified using asterisks (‘,”). Multiple prismatic cells 12 may form a rechargeable energy storage system (RESS) or battery pack 13 only partially shown. The prismatic cell 12 includes an outer facing first side 14 and a second bottom or second side 16 oriented substantially transverse to the first side 14. Individual prismatic cell geometries may vary, with the prismatic cell 12 having a generally rectangular shape including a width 18 and a height 20 that repeat between individual prismatic cells 12 of a battery pack 13 only partially shown. Prismatic cell terminals for withdrawing or recharging electrical power to the prismatic cell 12 are shown and described in greater detail in reference to FIGS. 13 and 14 and according to several aspects are located on a top facing or third side 22 oppositely facing with respect to the second side 16. The prismatic cell 12 further includes an outer facing or fourth side 24 oppositely facing with respect to the first side 14. The first side 14 and the fourth side 24 are substantially transversely oriented with respect to the second side 16 and the third side 22.

Referring to FIG. 2 and again to FIG. 1, a first cooling jacket system 26 provides simultaneous coolant flow for up to and including two contiguous sides of a prismatic cell as discussed below. According to several aspects the first cooling jacket system 26 includes two of the prismatic cells which may be cooled using a liquid cooling flow provided to remove heat generated by the two prismatic cells 12. According to several aspects cooling flow paths of the first cooling jacket system 26 may be configured as a cooling jacket defining an inverted T-jacket 28 of the prismatic cell cooling system 10. The inverted T-jacket 28 includes an upwardly directed wall 30 centrally positioned between and directly in contact with a first prismatic cell 12a of the two prismatic cells 12 and a second prismatic cell 12b of the two prismatic cells 12. The inverted T-jacket 28 further includes a first branch wall 32 fluidly, directly and contiguously connected to the upwardly directed wall 30, and a second branch wall 34 fluidly, directly and contiguously connected to the upwardly directed wall 30 and to the first branch wall 32.

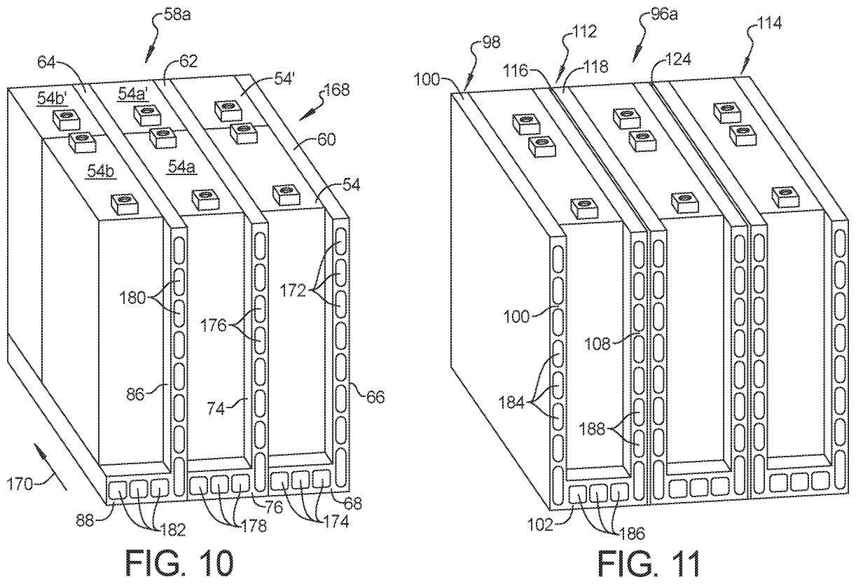

A cooling fluid may be directed to enter a cooling jacket via one more inner flow passages of the cooling jacket such as of the first branch wall 32, shown and described in greater detail in reference to FIGS. 10 through 14 in a first direction A, turn upward into the upwardly directed wall 30 in a second direction B, reverse direction at an upper end of the upwardly directed wall 30 in a third direction C, travel downward in the upwardly directed wall 30 and exit the first cooling jacket system 26 via inner flow passages of the second branch wall 34 in a flow direction D. The cooling fluid may be provided for example from a cooling system of the vehicle 11 described in reference to FIG. 1. The first cooling jacket system 26 provides simultaneous coolant flow to two contiguous sides of a prismatic cell.

Referring to FIG. 3 and again to FIGS. 1 and 2, the inverted T-jacket 28 provides internal cavities or fluid flow passages for directing coolant fluid. For example, the upwardly directed wall 30 includes a first internal cavity 40 and the first branch wall 32 and the second branch wall 34 also include a second internal pocket 42 provided for internal fluid flow. The inverted T-jacket 28 may also be modified using one or more flow redirection elements discussed below to redirect coolant flow as desired. According to several aspects, coolant flow may enter the second internal pocket 42 of the first branch wall 32 and the second branch wall 34 in a flow direction E until encountering an end wall 44, which redirects coolant flow in an upward direction F into the first internal cavity 40 of the upwardly directed wall 30. Within the first internal cavity 40 coolant flow may be initially directed in a flow direction G, which is reversed to flow in a counterflow direction H to the flow direction G. Coolant flow may exit the first internal cavity 40 in a flow direction J.

Turbulent flow is maintained by maximizing a Reynolds number to optimize heat removal. Turbulent flow may be achieved using flow modulators such as a first turbulator 46, a second turbulator 48 and a third turbulator 50 individually defining raised serpentine-shaped ribs provided on inside facing walls of the first internal cavity 40. Differing quantities of flow turbulators may also be used. In addition to providing directional control of the coolant flow, the first turbulator 46, the second turbulator 48 and the third turbulator 50 also provide continuous coolant flow change-of-direction, which maximizes turbulent flow of the coolant. In addition to or in lieu of the first turbulator 46, the second turbulator 48 and the third turbulator 50, multiple raised pins 53 which are fixedly connected to at least one internal facing wall of the first internal cavity 40 may be used to create turbulent flow and to change coolant flow direction change. After passing through the first internal cavity 40, coolant flow may exit the first internal cavity 40 at an end wall 52. In addition to the use of serpentine-shaped turbulators, turbulent flow may also be obtained through the use of turbulators defining straight fins, wave fins, pin fins, honeycombing, triangular-shaped fins, herringbone-shaped fins, and elliptical-shaped fins and the like.

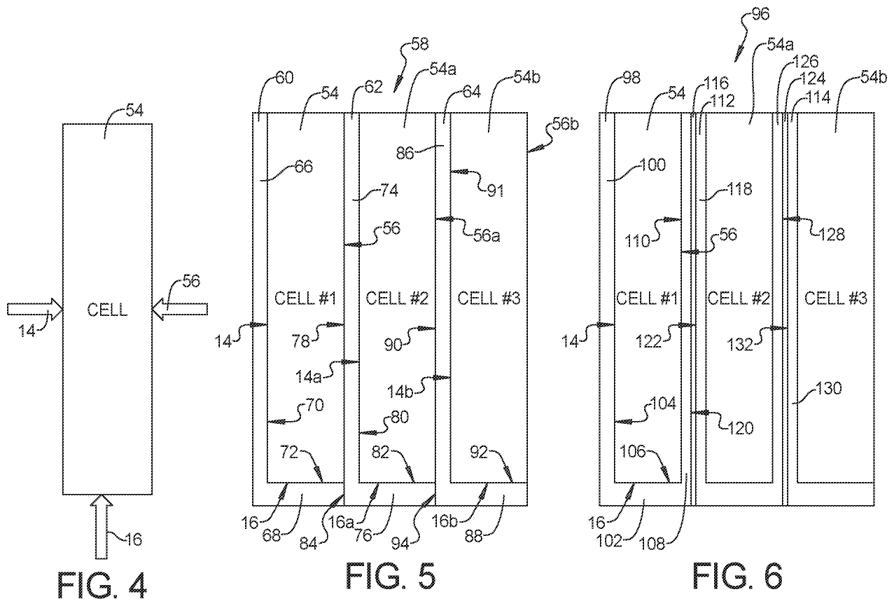

Referring to FIG. 4 and again to FIGS. 1 through 3, an individual prismatic cell 54 is similar to the prismatic cell 12. To further enhance prismatic cell cooling, in addition to providing simultaneous cooling of contiguously connected outer facing first side 14 and the bottom or second side 16, coolant flow may also be provided to an outer facing third side 56 which is oppositely facing with respect to the first side 14 and integrally and contiguously connected to the second side 16. Cooling may thereby be simultaneously provided to the first side 14, the second side 16 and the third side 56 using for example cooling jacket designs shown and described in greater detail in reference to FIGS. 5 and 6 described below.

Referring to FIG. 5 and again to FIG. 4, a second cooling jacket system 58 is modified from the first cooling jacket system 26 and provides simultaneous coolant flow for up to and including three contiguous sides of one or more prismatic cells as discussed below. According to several aspects the second cooling jacket system 58 includes three of the prismatic cells 54 defining a first prismatic cell 54, a second prismatic cell 54a and a third prismatic cell 54b which are substantially duplicates. The first prismatic cell 54, the second prismatic cell 54a and the third prismatic cell 54b may be cooled using a liquid cooling flow provided to remove heat generated by the three prismatic cells. According to several aspects cooling flow paths of the second cooling jacket system 58 may be configured using L-shaped jackets of the prismatic cell cooling system 10.

The second cooling jacket system 58 also includes a first L-shaped bracket 60, a second L-shaped bracket 62 and a third L-shaped bracket 64 which are similarly configured. The first L-shaped bracket 60 is positioned predominantly to a left-hand side of the first prismatic cell 54 as viewed in FIG. 5 and includes a first main body member 66 and is positioned outward of and in direct contact with the first side 14 of the first prismatic cell 54. A first base member 68 is oriented at a right angle with respect to the first main body member 66 and is directly and contiguously connected to the first main body member 66 and provides for fluid flow between the first main body member 66 and the first base member 68. The first side 14 of the first prismatic cell 54 is positioned in direct contact with a main body member inner wall 70, and the second side 16 of the first prismatic cell 54 is positioned in direct contact with a first base member inner wall 72.

With continuing reference to FIG. 5, a second main body member 74 of the second L-shaped bracket 62 is positioned predominantly between the first prismatic cell 54 and the second prismatic cell 54a. A second base member 76 is oriented at a right angle with respect to the second main body member 74 and is directly and contiguously connected to the second main body member 74 and provides for fluid flow between the second main body member 74 and the second base member 76. A first face 78 of the second main body member 74 is in direct contact with the third side 56 of the first prismatic cell 54. The second face 80 of the second main body member 74 is in direct contact with a first side 14a of the second prismatic cell 54a. The second side 16a of the second prismatic cell 54a is positioned in direct contact with a second base member inner wall 82 of the second base member 76. According to several aspects, the first base member 68 may be maintained in direct contact with the second base member 76, or an air gap 84 may be provided between the first base member 68 and the second base member 76.

With continuing reference to FIG. 5, a third main body member 86 of the third L-shaped bracket 64 is positioned predominantly between the second prismatic cell 54a and the third prismatic cell 54b. A third base member 88 is oriented at a right angle with respect to the third main body member 86 and is directly and contiguously connected to the third main body member 86 and provides for fluid flow between the third main body member 86 and the third base member 88. A first cell face 90 of the third main body member 86 is in direct contact with the third side 56a of the second prismatic cell 54a. A second cell face 91 of the third main body member 86 is in direct contact with the third side 56a of the second prismatic cell 54a. The second side 16b of the third prismatic cell 54b is positioned in direct contact with a third base member inner wall 92 of the third base member 88. According to several aspects the third side 56b of the third prismatic cell 54b may be open to atmosphere. According to several aspects, the second base member 76 may be maintained in direct contact with the third base member 88, or an air gap 94 may be provided between the second base member 76 and the third base member 88.

Referring to FIG. 6, a third cooling jacket system 96, similar to the second cooling jacket system 58, provides simultaneous coolant flow for up to and including three contiguous sides or faces of one or more prismatic cells as discussed below. According to several aspects the third cooling jacket system 96 includes three of the prismatic cells 54 defining the first prismatic cell 54, the second prismatic cell 54a and the third prismatic cell 54b which are substantially duplicates. The first prismatic cell 54, the second prismatic cell 54a and the third prismatic cell 54b may be cooled using a liquid cooling flow provided to remove heat generated by the three prismatic cells. According to several aspects cooling flow paths of the third cooling jacket system 96 may be configured using U-shaped jackets of the prismatic cell cooling system 10.

The third cooling jacket system 96 includes a first U-shaped bracket 98. The first U-shaped bracket 98 is positioned in direct contact with three sides of the first prismatic cell 54 as viewed in FIG. 6 and includes a first main body member 100 positioned outward of and in direct contact with the first side 14 of the first prismatic cell 54. A first base member 102 is oriented at a right angle with respect to the first main body member 100 and is directly and contiguously connected to the first main body member 100 and provides for fluid flow between the first main body member 100 and the first base member 102. The first side 14 of the first prismatic cell 54 is positioned in direct contact with a first main body member inner wall 104, and the second side 16 of the first prismatic cell 54 is positioned in direct contact with a first base member inner wall 106. A second main body member 108 is oriented substantially parallel with the first main body member 100 and is oriented at a right angle with respect to the first base member 102 and is directly and contiguously connected to the first base member 102 and provides for fluid flow between the second main body member 108 and the first base member 102. The third side 56 of the first prismatic cell 54 is positioned in direct contact with a second base member inner wall 110. The first prismatic cell 54 is positioned between and is in direct contact with the first main body member 100 and second main body member 108 and is also in direct contact with the first base member 102.

With continuing reference to FIG. 6, the third cooling jacket system 96 further includes a second U-shaped bracket 112 and a third U-shaped bracket 114 which partially encase the second prismatic cell 54a and the third prismatic cell 54b respectively. The second U-shaped bracket 112 and a third U-shaped bracket 114 include components, features and functions which are the same or similar to the components, features and functions discussed above with respect to the first U-shaped bracket 98, and therefore will not be discussed in greater detail herein. To mitigate against the possibility of a thermal runaway event occurring in a battery pack having the prismatic cells of the present disclosure, the third cooling jacket system 96 provides thermal insulation barriers positioned between adjoining prismatic cells. According to several aspects, a first thermal insulation barrier 116 is positioned between and in direct contact with the second main body member 108 and a main body member 118 of the second U-shaped bracket 112. The first thermal insulation barrier 116 is in direct contact with an outside directed face 120 of the second main body member 108 and oppositely is in direct contact with an outside directed face 122 of the main body member 118.

With continuing reference to FIG. 6, a second thermal insulation barrier 124 is positioned between the second U-shaped bracket 112 and the third U-shaped bracket 114. A third main body member 126 of the second U-shaped bracket 112 includes an outward directed face 128 in direct contact with the second thermal insulation barrier 124, and a first main body member 130 of the third U-shaped bracket 114 includes an outward directed face 132 in direct contact with the second thermal insulation barrier 124.

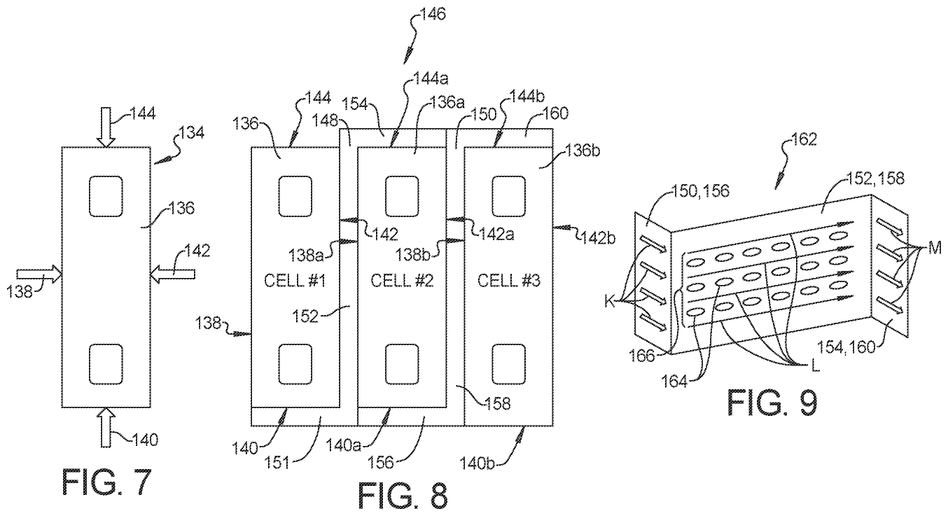

Referring to FIG. 7 and again to FIGS. 1 and 4, a four-faced prismatic cell cooling design 134 includes an individual prismatic cell 136 modified from the prismatic cell 12. To further enhance prismatic cell cooling, in addition to providing simultaneous cooling of an outer facing first side 138, a first end or second side 140, an outer facing third side 142 oppositely facing with respect to the outer facing first side 138, coolant flow may also be provided to a second end or fourth side 144 which is oppositely facing with respect to the second side 140. Cooling may thereby be simultaneously provided to the outer facing first side 138, the second side 140, the outer facing third side 142 and the fourth side 144 using for example cooling jacket designs shown and described in greater detail in reference to FIGS. 8 and 9 described below.

Referring to FIG. 8 and again to FIG. 7, a fourth cooling jacket system 146 may provide simultaneous coolant flow for up to and including four contiguous sides or faces of a prismatic cell as discussed below. The fourth cooling jacket system 146 provides Z-shaped cooling jackets such as a first Z-shaped cooling jacket 148 and a second Z-shaped cooling jacket 150. The first Z-shaped cooling jacket 148 includes a first base leg 151 directly in contact with the second side 140 of the prismatic cell 136, a first main leg 152 which is in direct contact with the third side 142 of the prismatic cell 136 and oppositely with a first side 138a of a prismatic cell 136a, and a second base leg 154 in direct contact with a fourth side 144a of the prismatic cell 136a.

The second Z-shaped cooling jacket 150 includes a first base leg 156 that abuts against the first base leg 150 and is directly in contact with a second side 140a of a prismatic cell 136a, a first main leg 158 which is in direct contact with a third side 142a of the prismatic cell 136a and oppositely with a first side 138b of a prismatic cell 136b, and a second base leg 160 in direct contact with a fourth side 144b of the prismatic cell 136b. According to several aspects, the fourth cooling jacket system 146 provides direct contact with a cooled portion of one of the first Z-shaped cooling jacket 148 and the second Z-shaped cooling jacket 150 to cool four sides of the prismatic cell 136. In the example shown, the first side 138 and the fourth side 144 of the prismatic cell 136 are not directly cooled, and the second side 140b and the third side 142b of the prismatic cell 136 are not directly cooled. The fourth cooling jacket system 146 may therefore be selected when a specific prismatic cell heat loading is identified.

Referring to FIG. 9 and again to FIG. 8, a coolant flow diagram 162 presents exemplary coolant flow paths for individual ones of the Z-shaped cooling jackets described above. Coolant flow is longitudinal in a flow direction K within the first base leg 150 and the first base leg 156. The first base leg 150 and the first base leg 156 are contiguously and fluidly connected to the first main leg 152 and the first main leg 158 respectively. Coolant flow is longitudinal in a flow direction L within the first main leg 152 and the first main leg 158 and may be rendered turbulent using one or more turbulation features 164 which are configured in geometric patterns including within rows 166 as shown. The first main leg 152 and the first main leg 158 are contiguously and fluidly connected to the second base leg 154 and the second base leg 160 respectively. Coolant flow is longitudinal in a flow direction M within the second base leg 154 and the second base leg 160.

Referring to FIG. 10 and again to FIG. 5, a second cooling jacket system 58a is shown in greater detail than the second cooling jacket system 58 described in reference to FIG. 5 and presents a portion of a battery pack 168 having exemplary coolant flow channels or passages. Multiple prismatic cells such as the prismatic cell 54 and a prismatic cell 54′ are configured in a cell alignment 170, and the battery pack 168 may also include multiple additional prismatic cells not shown for clarity.

Individual coolant flow passages or channels may include multiple flow channels 172 within the first main body member 66, multiple flow channels 174 extending through the first base member 68, multiple flow channels 176 extending through the second main body member 74, multiple flow channels 178 extending through the second base member 76, multiple flow channels 180 extending through the third main body member 86 and multiple flow channels 182 extending through the third base member 88. The multiple flow channels extend generally in parallel with the cell alignment 170. Coolant flow through individual ones of the multiple flow channels may be the same, may alternate or may be redirected based on prismatic cell heat loading and cooling rates desired.

Referring to FIG. 11 and again to FIG. 6, a third cooling jacket system 96a is shown in greater detail than the third cooling jacket system 96 described in reference to FIG. 6. Individual coolant flow passages or channels may include multiple flow channels 184 within the first main body member 100, multiple flow channels 186 extending through the first base member 102, multiple flow channels 188 extending through the second main body member 108. Additional and substantially identical coolant flow channels (shown) are provided for the second U-shaped bracket 112 and the third U-shaped bracket 114 but are not numbered for clarity. As noted in reference to FIG. 6, the first thermal insulation barrier 116 is positioned between and in direct contact with the second main body member 108 and the main body member 118 of the second U-shaped bracket 112, and the second thermal insulation barrier 124 is positioned between the second U-shaped bracket 112 and the third U-shaped bracket 114. The first thermal insulation barrier 116 and the second thermal insulation barrier 124 provide additional thermal isolation between prismatic cell packs to mitigate against thermal runaway of one or more of the prismatic cells or prismatic cell packs.

Coolant flow may be in any direction, inward or outward as viewed in reference to FIG. 11 for the coolant flow channels. Coolant flow may also enter one coolant flow passage and reverse to exit from an adjacent one of the coolant flow channels. This permits optimizing heat removal for different prismatic cell and batter cell pack design requirements.

A prismatic cell format defines a heat generation source. The cooling jackets may include a design responsible for containing a heat transfer fluid and thermally conducting heat between the heat generation source such as the battery cell or prismatic cell, and the heat sink or cooling jacket.

Features of the prismatic cell cooling system 10 may include: 1) integrated multi-surface cooling concepts providing an increased effective cooling area; 2) an L-shaped jacket, a U-shaped jacket, an inverted T-shaped jacket, a Z-shaped jacket and turbulation features to enhance performance capabilities of cooling jackets independent of the multi-surface cooling benefits such as increased Reynolds number and thermal conductivity such as straight fins, wave fins, pin fins, honeycombing, triangular, herringbone, and elliptical fins.

Materials used for the cooling jacket systems of the prismatic cell cooling jacket system 10 of the present disclosure may include: aluminum which is affordable, provides a medium thermal conductivity, and is lightweight; copper which provides high thermal conductivity, however is heavier than aluminum; and steel which is affordable, but provides reduced thermal conductivity compared to copper and is heavy.

Multi-port cooling and manifolding: a cooling jacket may facilitate the distribution of coolant flow to inlets and outlets, integration between a rechargeable energy storage system (RESS) thermal and vehicle thermal loops, and coolant system sealing & containment. Thermal interface material (TIM) defines an adhesive or filler layer is applied to prismatic cell surfaces to match uneven surfaces between prismatic cells. The design of the present cooling jacket designs promote accommodating dispensing of TIM to further promote a thermal benefit through the TIM material's thermal conductivity properties including having a low coefficient of thermal transfer.

The prismatic cell cooling jacket system 10 of the present disclosure provides integrated multi-surface thermal management of prismatic cells using the cooling capability of variable length cooling jackets and RESS spatial dimensions. The prismatic cell cooling jacket system 10 of the present disclosure provides a modular thermal system. The prismatic cell cooling jacket system 10 of the present disclosure supports cell-to-module, cell-to-pack and module-to-RESS structure.

The prismatic cell cooling jacket system 10 of the present disclosure includes multiple continuous or staggered turbulation features that may be implemented in the cooling channels such as the straight micro channels, the wave turbulators, flow redirection pins, fin arrays, and other fin forms. The prismatic cell cooling jacket system 10 of the present disclosure includes cooling ports, both inlets & outlets having the ability to integrate to cooling jackets. The prismatic cell cooling jacket system 10 of the present disclosure provides a repeatable thermal management solution for prismatic cells including high performance prismatic cells such as in vehicles including but not limited to sports cars, towing vehicles and the like, which may generate greater heat than nominal performing vehicles during normal driving operations and provides a rechargeable energy storage system using multi-surface liquid cooling jackets and manifolding.

A prismatic cell cooling jacket system 10 of the present disclosure offers several advantages. These include but are not limited to increased thermal performance, reduced maximum cell internal temperatures, reduced local cell temperature gradients, improved vehicle endurance, an ability to accommodate variable RESS geometries including T-shape, H-shape, flat pack, suitcase pack, and the like, reduced thermal resistance from a center plane of the prismatic cell to a heat sink, reduced cost and improved manufacturability for mass production. Cooling jacket concepts of the present disclosure also provide supporting structure for multiple cells to aid manufacturing. The exemplary shapes of cooling jackets presented herein optimize a thermal efficiency, reduce pressure drop, and achieve fluid flow uniformity, and the cooling jackets provide the capability to act as a spring clamp to manage thermal interface materials (TIM).

What is claimed is:

1. A prismatic cell cooling system, comprising:
a first prismatic cell having a first face, a second face angularly oriented to the first face and a third face oriented parallel to the first face and angularly oriented to the second face;
a cooling jacket providing multiple coolant flow passages;
a first cooling segment of the cooling jacket contacting one of the first face or the third face of the first prismatic cell; and
a second cooling segment of the cooling jacket directly contacting the second face of the first prismatic cell, the second cooling segment contiguously and fluidly connected to the first cooling segment to promote simultaneous cooling of one of the first face or the third face and the second face of the first prismatic cell by flow of a coolant through the coolant flow passages.

2. The prismatic cell cooling system of claim 1, further including a second prismatic cell having a cell first face, a cell second face angularly oriented to the cell first face and a cell third face oriented parallel to the cell first face and angularly oriented to the cell second face, the second prismatic cell positioned proximate the first prismatic cell.

3. The prismatic cell cooling system of claim 2, wherein the cooling jacket defines a T-shape having the first cooling segment positioned between and directly contacting the first prismatic cell and the second prismatic cell, the cooling jacket having the second cooling segment also directly contacting the cell second face of the second prismatic cell.

4. The prismatic cell cooling system of claim 2, wherein the cooling jacket defines an L-shape having the first cooling segment positioned between and directly contacting the first prismatic cell and the second prismatic cell, the cooling jacket having the second cooling segment directly contacting one of the second face of the first prismatic cell or the cell second face of the second prismatic cell.

5. The prismatic cell cooling system of claim 2, wherein the cooling jacket defines a Z-shape having the first cooling segment positioned between and directly contacting the first prismatic cell and the second prismatic cell, the cooling jacket having the second cooling segment also directly contacting the second face of the first prismatic cell, and the cooling jacket including a third cooling segment directly contacting a fourth face of the second prismatic cell.

6. The prismatic cell cooling system of claim 2, wherein the cooling jacket defines a U-shape having the first cooling segment positioned between and directly contacting the first prismatic cell and the second prismatic cell, the cooling jacket having the second cooling segment directly contacting one of the second face of the first prismatic cell or the cell second face of the second prismatic cell.

7. The prismatic cell cooling system of claim 2, including:
a third prismatic cell;
wherein:
the first cooling segment partially encloses the first prismatic cell;
the second cooling segment partially encloses the second prismatic cell; and
a third cooling segment of the cooling jacket partially encloses the third prismatic cell.

8. The prismatic cell cooling system of claim 7, further including:
a first thermal insulation barrier positioned between and in direct contact with the first cooling segment and the second cooling segment; and
a second thermal insulation barrier positioned between and in direct contact with the second cooling segment and the third cooling segment.

9. The prismatic cell cooling system of claim 1, wherein the cooling jacket includes multiple flow turbulators extending into the coolant flow passages to generate turbulent flow of the coolant, having individual ones of the flow turbulators defining one of a serpentine-shape and a raised pin.

10. The prismatic cell cooling system of claim 1, wherein the second face is oriented substantially perpendicular to the first face and the third face is oriented parallel to the first face and substantially perpendicular to the second face.

11. A vehicle prismatic cell cooling system, comprising:
at least a first prismatic cell and a second prismatic cell individually having a first face, a second face angularly oriented to the first face and a third face oriented parallel to the first face and angularly oriented to the second face;
a first cooling jacket providing multiple coolant flow passages, the first cooling jacket in direct contact with the first prismatic cell;
a first cooling segment of the first cooling jacket contacting one of the first face or the third face of the first prismatic cell; and
a second cooling segment of the first cooling jacket directly contacting the second face of the first prismatic cell, the second cooling segment contiguously and fluidly connected to the first cooling segment to promote simultaneous cooling one of the first face or the third face and the second face of at least the first prismatic cell by flow of a coolant through the coolant flow passages.

12. The vehicle prismatic cell cooling system of claim 11, further including a second cooling jacket, wherein the second cooling jacket is in direct contact with the second prismatic cell.

13. The vehicle prismatic cell cooling system of claim 11, further including:
a third prismatic cell provided with the at least first and second prismatic cells; and
a third cooling jacket, the first cooling jacket in direct contact with the first prismatic cell, the second cooling jacket in direct contact with the second prismatic cell and the third cooling jacket in direct contact with the third prismatic cell.

14. The vehicle prismatic cell cooling system of claim 13, wherein:
the first cooling jacket is further in direct contact with the second prismatic cell; and
the second cooling jacket is in direct contact with the third prismatic cell.

15. The vehicle prismatic cell cooling system of claim 11, further including a second cooling jacket, wherein the first cooling jacket is in direct contact with the first prismatic cell and the second cooling jacket is in direct contact with the second prismatic cell.

16. The vehicle prismatic cell cooling system of claim 15, further including a thermal insulation barrier positioned between and in direct contact with the first cooling jacket and the second cooling jacket.

17. The vehicle prismatic cell cooling system of claim 11, wherein a material used for the first cooling jacket includes one of: aluminum, copper and steel, and the first cooling jacket includes multiple turbulation features formed within at least one the first cooling segment and the second cooling segment to increase flow turbulence of the coolant.

18. A method for cooling vehicle prismatic cells using cooling jackets, comprising:
configuring at least a first prismatic cell and a second prismatic cell individually having a first face, a second face angularly oriented to the first face and a third face oriented parallel to the first face and angularly oriented to the second face;
positioning a first cooling jacket in direct contact with at least one of the first prismatic cell or the second prismatic cell and providing multiple coolant flow passages within the first cooling jacket;
placing a first cooling segment of the first cooling jacket having multiple ones of the multiple coolant flow passages in contact with one of the first face or the third face of the at least one of the first prismatic cell or the second prismatic cell;
locating a second cooling segment of the first cooling jacket having multiple ones of the multiple coolant flow passages in direct contact with the second face of the at least one of the first prismatic cell or the second prismatic cell, the second cooling segment contiguously and fluidly connected to the first cooling segment to simultaneously cool one of the first face or the third face and the second face of the at least one of the first prismatic cell or the second prismatic cell by flow of a coolant through the coolant flow passages.

19. The method of claim 18, further including:
selecting the first cooling jacket to be in direct contact with the first prismatic cell; and
locating a second cooling jacket in direct contact with the second prismatic cell.

20. The method of claim 19, further including thermally isolating the first cooling jacket from the second cooling jacket by positioning a first thermal insulation barrier between and in direct contact with the first cooling jacket and the second cooling jacket.
